(19) United States
(12) Patent Application Publication
(10) Pub. No.: US 2006/0218416 A1
(43) Pub. Date: Sep. 28, 2006

(54) Use of multiple operating RPMs in a hard disk drive to save energy

(75) Inventors: Raghu Gururangan, Pleasanton, CA (US); Fernando A. Zayas, Loveland, CO (US); Thorsten Schmidt, Milpitas, CA (US)

Correspondence Address: FLIESLER MEYER, LLP, FOUR EMBARCADERO CENTER, SUITE 400, SAN FRANCISCO, CA, 94111, US

(73) Assignee: Matsushita Electric Industrial Co., Ltd., Kadoma-shi (JP)

(21) Appl. No.: 11/088,553

(22) Filed: Mar. 24, 2005

(51) Int. Cl. G06F 1/26

(52) U.S. Cl. 713/300

(57) ABSTRACT

A hard disk drive determines whether the hard disk drive is powered by a battery. This determination is used to select an operating RPM value for the hard disk drive. The fly height of a slider on a hard disk drive can be tested at a low operating RPM value. If the fly height is acceptable, the low operating RPM value is enabled to be selectable for the disk drive. In addition to a low operating RPM value, a high operating RPM value can also be selectable.

### FIELD OF THE INVENTION

The present invention relates to hard disk drives.

### BACKGROUND

Hard disk drives are an integral part of computers and other devices with needs for large amounts of reliable memory. Hard disk drives are inexpensive, relatively easy to manufacture, forgiving where manufacturing flaws are present, and capable of storing large amounts of information in relatively small spaces.

A typical hard drive device having a rotatable storage medium includes a head disk assembly and electronics to control operation of the head disk assembly. The head disk assembly can include one or more disks. In a magnetic disk drive, disks include a recording surface to receive and store user information. The recording surface can be constructed of a substrate of metal, ceramic, glass or plastic with a thin magnetizable layer on either side of the substrate. Data is transferred to and from the recording surface via a head mounted on an arm of the actuator assembly. Heads can include one or more read and/or write elements, or read/write elements, for reading and/or writing data. Drives can include one or more heads for reading and/or writing. In magnetic disk drives, heads can include a thin film inductive write element and a magneto-resistive read element. An actuator, such as a voice coil motor (VCM) actuator, is used to position the head assembly over the correct track on a disk by rotating the arm.

### BRIEF SUMMARY

Embodiments of the present invention use multiple operating revolutions per minute (RPMs). In one embodiment, when a hard disk drive is powered by a battery source, a low operating RPM value is used. When the hard disk drive is powered using an electrical socket, a high RPM value is used. The low operating RPM value can result in lower power consumption when using a battery. The use of the low RPM value can be selectable by the user.

In one embodiment, a fly height test is done to determine an acceptable low operating RPM value for a specific hard disk drive. The lower operating RPM can be selected from a number of candidate low operating RPM values.

### BRIEF DESCRIPTION OF THE DRAWINGS

FIG. 1 is a diagram of a hard disk drive of one embodiment of the present invention.

FIG. 2 is a flow chart that illustrates embodiments of the present invention.

FIG. 3 is a diagram that illustrates an exemplary graph of fly height versus RPM.

### DETAILED DESCRIPTION

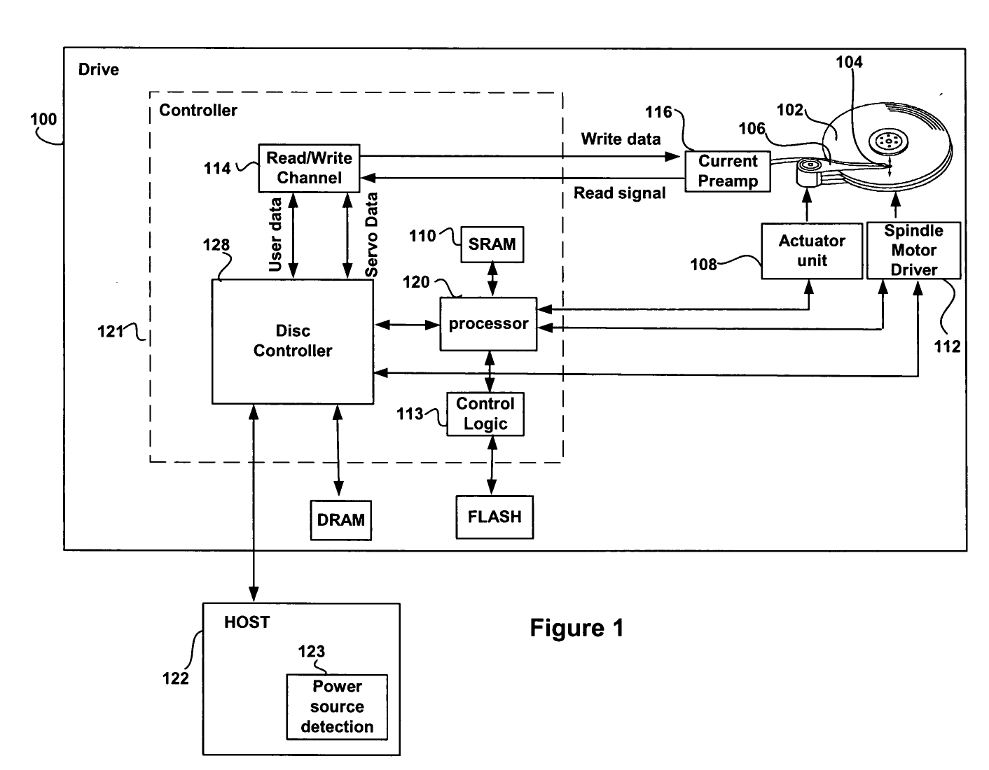

FIG. 1 shows a rotating media storage device 100 that can be used in accordance with one embodiment of the present invention. In this example, the rotating media storage device 100 is a hard disk drive. The rotating media storage device 100 includes at least one rotatable storage medium 102 capable of storing information on at least one surface. Numbers of disks and surfaces may vary by disk drive. In a magnetic disk drive, storage medium 102 is a magnetic disk. A closed loop servo system, including an actuator arm 106, can be used to position head 104 over selected tracks of disk 102 for reading or writing, or to move head 104 to a selected track during a seek operation. In one embodiment, head 104 is a magnetic transducer adapted to read data from and write data to the disk 102. In another embodiment, head 104 includes separate read elements and write elements. The read element can be a magnetoresistive (MR) head. Multiple head configurations may be used.

The head is typically positioned upon a slider which flies close to the disk. The distance between the slider and the disk is called the fly height and is typically on the order of 10 nanometers. The fly height is one of the most important design parameters of a hard disk. If the heads are too high above the surface of the disk then data errors can occur. If the heads are too low, a head crash becomes more likely.

The servo system can include an actuator unit 108, which may include a voice coil motor driver to drive a voice coil motor (VCM) for rotating of the actuator arm 106. The servo system can also include a spindle motor driver 112 to drive a spindle motor (not shown) for rotation of the disk 102. Controller 121 can be used to control the rotating media storage device 100. In one embodiment, the controller 121 includes a disk controller 128, read/write channel 114, processor 120, SRAM 110, and control logic 113 on one or more chips. The controller can include fewer elements as well. Current preamp 116 can be used to read and write data.

The disk 102 is rotated at an operating revolutions per minute (RPM) value. The operating RPM value affects the speed at which data can be read from the disk. The slower the operating RPM value, the longer the system may have to wait to obtain a specific stored data element. The operating RPM value also affects power consumption. Higher RPM values can result in increased power use.

In traditional hard disk drives, the rotatable disk spins at a single operating RPM value. Although, the RPM of the disk ramps up to and down from this operating RPM value, only a single operating RPM value is typically used. Embodiments of the present invention use multiple operating RPMs. Low operating RPM values can be used to save power when a computer, such as a laptop, is powered from a battery.

In one embodiment of the present invention, multiple operating RPM values are selectable. Each of the multiple operating RPM values can be chosen to avoid resonance modes of the disk drive. Additionally, the disk drive is designed to read and write data at each of the operating RPM values.

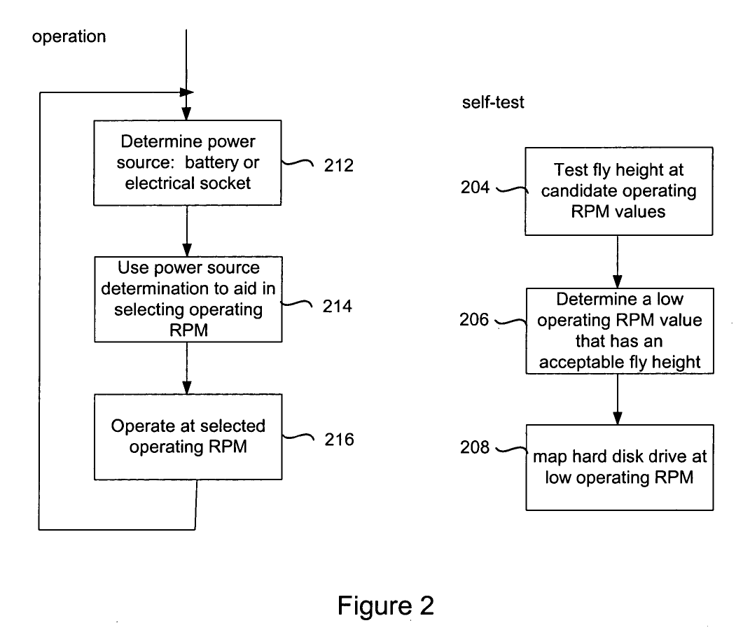

FIG. 2 are flowcharts that illustrate methods of embodiments of the present invention. One embodiment of the present invention concerns the operation of the hard disk. In step 212, the power source for the hard disk drive is determined. Looking at FIG. 1, typically the power for the drive 100 is provided through the host 122. The host 122 can be powered by a battery or from an electrical socket. An indication of the power source can be produced by a power source detection element 123 of the host 122. When power is provided by an electrical socket, power is not drawn from the battery and in many cases the battery is recharged using the electrical socket power. The indication of the power source can be provided from the host 122 to the drive 100. This information can be provided in a conventional information transfer, such as an Advanced Technology Attachment (ATA) transfer, between the host 122 and the drive 100. Alternately, the power source can be determined by the hard disk or in another manner.

In step 214, the determination of the power source is used to aid in the selection of the operating RPM. In one embodiment, a low operating RPM is selected if the hard disk drive is powered by a battery and a high operating RPM is selected if the hard disk drive is powered from the electrical socket.

In another embodiment, an indication is stored to indicate whether the low operating RPM value is currently selectable. This indication can be produced in response to user input. In one example, the user indicates whether the low operating RPM value will be used when the hard disk drive is powered by the battery. In this example, when the indication allows for low RPM operation and the hard drive is being powered by the battery, the low operating RPM value is used; otherwise a high operating RPM value is used. The selection of the low or high operating RPM value can be done by the controller 121 or by the host 122.

In step 216, the drive 100 operates at the selected RPM value. In one embodiment, the disk controller 121 controls the spindle motor driver 112 to rotate the disks at the selected operating RPM value.

FIG. 2 also shows a self-test method of one embodiment of the present invention. In step 204, the fly height is determined at different candidate operating RPMs. In one embodiment, the disk drive has a high operating RPM value in addition to multiple candidate low operating RPM values. The candidate low operating RPM values and high operating RPM value can be chosen to avoid resonance frequencies. The determination of the operating RPM values can be somewhat simplified by the use of fluid bearing spindles which have fewer resonance frequencies than ball bearing spindles. The servo sample rate of the disk drive is selected to operate at each of the operating RPMs.

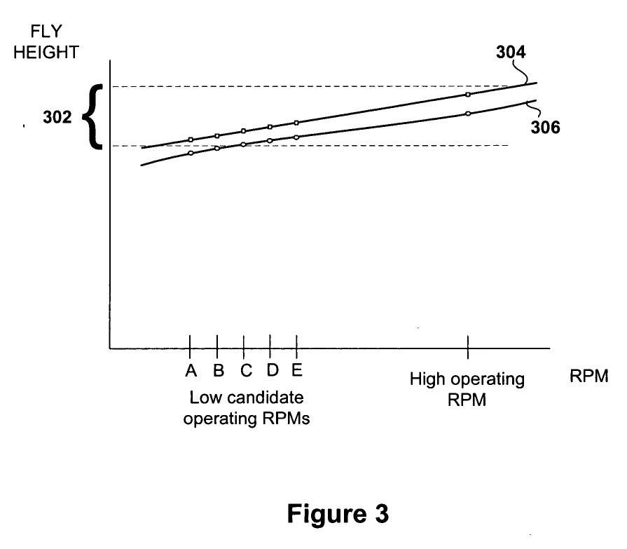

In step 206, a low operating RPM value with an acceptable fly height is determined. In one embodiment, the lowest candidate operating RPM having an acceptable fly height is chosen. For example, in FIG. 3, for the disk drive of curve 304, low operating RPM value A is selected. For the disk drive of curve 306, the low operating RPM value C is chosen.

In step 208, the hard disk drive is mapped at the selected low operating RPM. In one embodiment, Thermal Asperities (TAs) and Non-repeatable Run Out (NRO) are determined at the selected low operating RPM value. Thermal Asperities can result when a location on a disk is warped. The head can contact the disk and a false thermal created. After these problem regions are mapped, they can be avoided during operation of the hard disk drive at both the low and high operating RPMs.

FIG. 3 is a diagram that illustrates fly height versus operating RPM. FIG. 3 shows the acceptable nominal fly height range 302. If the slider is too far from the disk, there can be data errors. If the slider is too close to the disk, the slider can crash into the disk.

Additional factors also affect the desired nominal fly height range 302. The fly height is affected by atmospheric pressure which depends upon the altitude that the hard disk drive is being used. For example, low atmospheric pressure causes the real fly height to be reduced. Disk drive wear, including dirt accumulation on the head, can also reduce the real fly height after initial testing. For this reason, the nominal fly height range 302 preferably has a built-in margin of error to allow for changes in atmospheric pressure and other factors. In one example, the acceptable fly height range is between 10 and 20 nanometers.

The determination of fly height can be done in a number of ways. These include interferometer or capacitive-based methods. One way to measure the fly height is to determine the relative decay of detected signals at different written frequencies on the disk. Depending on the frequency that information is written upon the disk, the detected intensity of the signal will decay with the fly height differently. This difference can be used to determine the fly height. In one embodiment, two test patterns are written onto the disk. One test pattern having relatively high frequency and the other test pattern having a relatively low frequency. Differences in the detected signals at the head can then be used to calculate the fly height.

In the example of FIG. 3, the fly height of a number of candidate operating RPMs is tested. Each of the operating RPMs is chosen to avoid resonance modes of the disk drive. Additionally the servo control and other systems are designed so that they will operate at each of the low candidate operating RPMs. For example, the servo sample rate is set such that it will work each of the operating RPMs.

Due to process variations in the construction of the disk drive, it is possible that each disk drive will have a different fly height to RPM curve. In the example of FIG. 3, one disk drive has a curve 304 while the other hard disk has curve 306. In this example, for the disk drive that has curve 304, each of the low candidate operating RPMs is within the acceptable fly height range 302. For the disk drive of curve 306, only the candidate low operating RPMs C, D and E are within the acceptable fly height range 302. For a hard drive with multiple heads, the RPM can be determined by the lowest flying head in the head stack.

In one embodiment, the hard disk has a fly height sensor that can be used to test the fly height during the life cycle of the disk drive. The fly height at different candidate low RPM values can be tested periodically. If the prior low operating RPM value currently has an unacceptable fly height due to atmospheric pressure or disk drive wear, a new low operating RPM value may be enabled or the use of low operating RPM values can be temporarily disabled.

The RPM values for a multiple operating RPM system can be selected to avoid certain resonances. A self-test can be used to decide which lower RPM(s) are allowed to avoid these resonances.

The RPM values selected can be dependent on the temperature. That is, different RPM values can be stored and used for different drive temperatures.

If more than one lower RPM are allowable, the amount of battery life remaining can determine the selection. At lower battery life situations, the RPM can be decreased.

In one embodiment, the user can override the selection of a lower RPM. In one embodiment, the user is allowed to select the performance option even if the disk drive is using battery power.

The fly height test can be repeated throughout the life of the hard disk drive. Over the life of the drive, as the measured flying height decreases, the operating lower RPM(s) can be raised or some of the lowest RPMs from the list of operating RPMs can be discarded.

The lower RPM need not be a fixed value, and it can become an operating RPM rather than just a feature of self-test.

The foregoing description of preferred embodiments of the present invention has been provided for the purposes of illustration and description. It is not intended to be exhaustive or to limit the invention to the precise forms disclosed. Many embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the claims and their equivalents.

What is claimed is:

1. A method of operating a hard disk drive that can be powered from a battery or from an electrical socket, the method comprising:
determining whether the hard disk drive is powered from the battery or from the electrical socket;
using the determination to aid in the selection of an operating revolutions per minute (RPM) for operating the rotatable disk of the hard disk drive read and write data; and
operating the rotatable disk of the hard disk drive at the selected operating RPM.

2. The method of claim 1, wherein a low operating RPM is selected if the hard disk drive is powered from the battery, and a high operating RPM is selected if the hard disk drive is powered from the electrical socket.

3. The method of claim 1, wherein the selection is such that an indication is stored to indicate whether a low operating RPM value is used when the hard disk drive is powered from the battery

4. The method of claim 3, wherein the indication is produced in response to a user selection.

5. The method of claim 1, wherein the power source determination uses an indication obtained from a host device.

6. The method of claim 1, wherein the selection of the operating RPM value is done by a controller in the hard disk drive.

7. The method of claim 1, wherein the selection of the operating RPM value is done by a host device.

8. A method comprising:
testing the fly height of a slider on a hard disk drive at a low operating revolutions per minute (RPM) value; and
if the fly height is acceptable, enabling the low operating RPM value to be selectable for the disk drive, wherein in addition to the low operating RPM value a high operating RPM value is also selectable.

9. The method of claim 8, wherein the low operating RPM value is one of a number of candidate low operating RPM values.

10. The method of claim 9, wherein the hard disk drive is designed to work at each of the candidate low operating RPM values.

11. The method of claim 9, wherein the lowest RPM value of the candidate low operating RPM values that has an acceptable fly height is enabled to be selectable.

12. The method of claim 8, wherein if the fly height is acceptable, the hard disk drive is mapped at the low operating RPM.

13. The method of claim 12, wherein if the fly height is acceptable, the non-repeatable runout is mapped at the low operating RPM.

14. The method of claim 8, wherein the disk drive is tested throughout the life of the disk drive to determine acceptable RPM values.

15. The method of claim 8, wherein the low operating RPM is selected if the hard disk drive is powered from the battery, and the high operating RPM is selected if the hard disk drive is powered from the electrical socket.

16. The method of claim 8, wherein a stored indication indicates whether the low operating RPM value is used when the hard disk drive is powered from the battery

17. The method of claim 8, wherein a user can select whether to use a lower operating RPM value.

18. The RPM is a method of claim 8, wherein the RPM value is selected to avoid resonances.

19. The method of claim 8, wherein the RPM value selected depends on the disk drive temperature.

20. The method of clam 8, wherein the PRM value is selected based on battery life.
